(19) United States
(12) Patent Application Publication
(10) Pub. No.: US 2014/0310520 A1
(43) Pub. Date: Oct. 16, 2014

(54) METHOD FOR COMMUNICATING DATA AND ELECTRONIC DEVICE THEREOF

(71) Applicant: Samsung Electronics Co., Ltd., Gyeonggi-do (KR)

(72) Inventors: Hak-Bong CHO, Gyeonggi-do (KR); In-Chul LEE, Gyeonggi-do (KR)

(73) Assignee: Samsung Electronics Co., Ltd., Gyeonggi-do (KR)

(21) Appl. No.: 14/254,260

(22) Filed: Apr. 16, 2014

(30) Foreign Application Priority Data
Apr. 16, 2013 (KR) 10-2013-0041615

(51) Int. Cl. H04L 29/08; G06F 21/62

(52) U.S. Cl. CPC H04L 67/06; G06F 21/6218
USPC 713/165; 709/226

(57) ABSTRACT

A method for transmitting control data and an electronic device are provided. The electronic device includes a control data processor for generating control data, and a file processor for generating a control data file comprising the control data generated by the control data processor and transmitting the control data file to another electronic device using a file transfer protocol.

### PRIORITY

The present application claims priority under 35 U.S.C. §119(a) to a Korean Patent Application filed in the Korean Intellectual Property Office on Apr. 16, 2013, and assigned Serial No. 10-2013-0041615, the entire disclosure of which is incorporated herein by reference.

### BACKGROUND

1. Field of the Invention

The present invention generally relates to a method for communicating data and an electronic device thereof.

2. Description of the Related Art

An electronic device can send and receive serial data such as an AT command or OBject EXchange (OBEX), and a user file such as a multimedia service to and from another electronic device connected via a wired communication link. For example, the electronic device can send and receive the serial data to and from the other electronic device over a serial data channel, and send and receive the user file to and from the other electronic device over a file transfer channel separately from the serial data channel. Herein, the serial data can instruct the electronic device to operate with the other electronic device and to respond to a command.

To transmit and receive the serial data and the file to and from the other electronic device, the electronic device needs to retain a plurality of channels including the serial data channel and the file transfer channel. For doing so, the electronic device has to install a plurality of drivers for the channels and to maintain the channels.

### SUMMARY OF THE INVENTION

The present invention has been made to address at least the above problems and disadvantages, and to provide at least the advantages described below.

Accordingly, an aspect of the present invention is to provide an apparatus and a method of an electronic device for reducing load of data transmission and reception with another electronic device.

Another aspect of the present invention is to provide an apparatus and a method of an electronic device for reducing load of data transmission and reception with another electronic device connected via a wired communication link.

Yet another aspect of the present invention is to provide an apparatus and a method of an electronic device for sending and receiving a file and user data to and from another electronic device over a single channel.

Still another aspect of the present invention is to provide an apparatus and a method of an electronic device for sending and receiving control data to and from another electronic device over a file transfer channel.

A further aspect of the present invention is to provide an apparatus and a method of an electronic device for sending and receiving control data to and from another electronic device connected via a wired communication link over a file transfer channel.

According to an aspect of the present invention, an apparatus of an electronic device includes a control data processor for generating control data; and a file processor for generating a control data file comprising the control data generated by the control data processor, and transmitting the control data file to another electronic device using a file transfer protocol.

According to another aspect of the present invention, an apparatus of an electronic device includes a file processor for receiving a control data file from another electronic device over a file transfer channel, and extracting control data from the control data file; and a control data processor for processing a control command of the control data extracted by the file processor.

According to yet another aspect of the present invention, a method for transmitting control data in an electronic device includes generating a control data file comprising control data; and transmitting the control data file to another electronic device using a file transfer protocol.

According to still another aspect of the present invention, a method for processing control data in an electronic device includes receiving a control data file from another electronic device over a file transfer channel, and extracting control data from the control data file and processing a control command of the control data.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram of a system for transmitting control data according to an embodiment of the present invention;

FIG. 2 is a block diagram of an electronic device according to an embodiment of the present invention;

FIG. 3 is a detailed block diagram of a processor according to an embodiment of the present invention;

FIG. 4 is a flowchart of a method for transmitting the control data in the electronic device according to an embodiment of the present invention;

FIG. 5 is a flowchart of a method for processing the control data in the electronic device according to an embodiment of the present invention;

FIGS. 6A, 6B, and 6C are flowcharts of a method for transmitting the control data in the electronic device according to another embodiment of the present invention;

FIGS. 7A, 7B, and 7C are flowcharts of a method for processing the control data in the electronic device according to another embodiment of the present invention;

FIGS. 8A, 8B, and 8C are flowcharts of a method for transmitting the control data in the electronic device according to another embodiment of the present invention; and

FIGS. 9A, 9B, and 9C are flowcharts of a method for processing the control data in the electronic device according to another embodiment of the present invention.

Throughout the drawings, like reference numerals will be understood to refer to like parts, components and structures.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded as merely examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to their dictionary meanings, but, are merely used to enable a clear and consistent understanding of the invention. Accordingly, it should be apparent to those skilled in the art that the following description of embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Embodiments of the present invention provide a technique for transmitting and receiving control data in an electronic device.

Herein, the control data can include serial data such as AT command or OBject EXchange (OBEX). For example, the control data can include one or more of a control channel setting signal, a control channel release signal, a command to operate another electronic device, and a response to the command.

The electronic device can be a portable electronic device, a portable terminal, a mobile terminal, a mobile pad, a media player, a Personal Digital Assistant (PDA), a desktop computer, a laptop computer, a smart phone, a netbook computer, a television, a Mobile Internet Device (MID), an Ultra Mobile Personal Computer (UMPC), a tablet PC, a navigation system, a smart TV, a wrist watch, a digital camera, and an MP3 player. The electronic device may be an electronic device combining two or more functions of these devices.

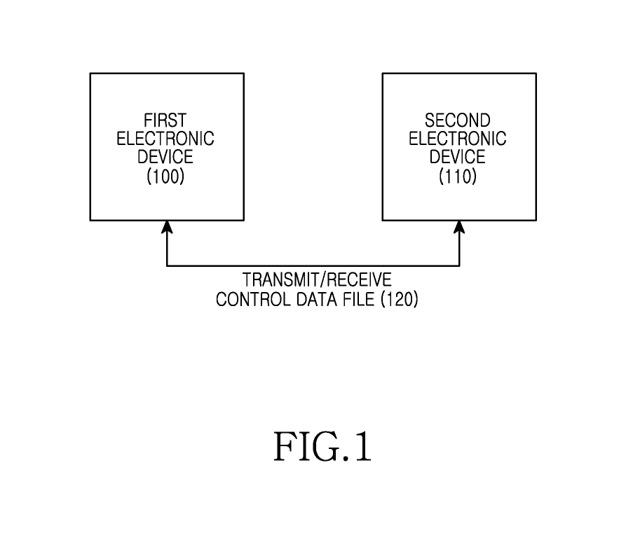

FIG. 1 is a block diagram of a system for transmitting the control data according to an embodiment of the present invention.

As shown in FIG. 1, when a communication link is connected between a first electronic device 100 and a second electronic device 110, the first electronic device 100 and the second electronic device 110 send and receive control data and a user file over a file transfer channel 120. For example, when the first electronic device 100 and the second electronic device 110 are connected via a wired communication link, the first electronic device 100 and the second electronic device 110 may send and receive at least one of the control data being a file and the user file for a multimedia service over the file transfer channel 120. In so doing, the first electronic device 100 and the second electronic device 110 identify the file type using a file header. Herein, the user file includes contents for the multimedia service, such as music file and video file.

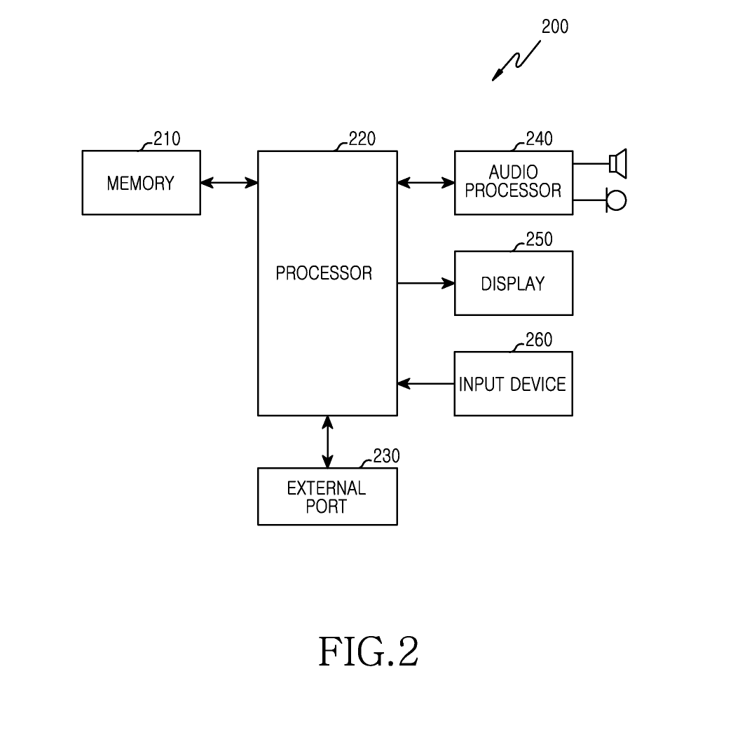

FIG. 2 is a block diagram of the electronic device according to an embodiment of the present invention.

As shown in FIG. 2, the electronic device 200 includes a memory 210, a processor 220, an external port 230, an audio processor 240, a display 250, and an input device 260. Herein, at least one of the processor 220, the memory 210, and the external port 230 can include a plurality of each.

The memory 210 includes a program storage for storing a program to control operations of the electronic device 200 and a data storage for storing data generated in the program execution. The memory 210 can include a volatile memory (e.g., Random Access Memory (RAM)), a non-volatile memory (e.g., flash memory), or a combination of both.

The processor 220 controls the electronic device 200 to provide various multimedia services using at least one software program. For example, the processor 220 executes at least one program stored in the memory 210 and thus controls to provide the multimedia service corresponding to the program.

The processor 220 controls to transmit and receive the control data and the user file to and from the other electronic device connected via the external port 230, over the file transfer channel. For example, when the other electronic device is connected via the external port 230, the processor 220 controls to transmit the control data and the user file to the other electronic device over the file transfer channel. That is, the processor 220 controls to generate a control data file and sends the control data file to the other electronic device. For example, the processor 220 may control to execute a control command of the control data file received from the other electronic device over the file transfer channel.

The external port 230 includes a connection interface for connecting the electronic device 2100 to the other electronic device directly or via a network. For example, the external port 230 can include one or more of a Universal Serial Bus (USB) port and a High Definition Multimedia Interface (HDMI) port.

The audio processor 240 provides an audio interface between a user and the electronic device 200 through a speaker and a microphone.

The display 250 displays status information of the electronic device 200, characters input by the user, a moving picture, or a still picture. For example, the display 250 can display multimedia service information of the processor 200.

The input device 260 provides the processor 220 with input data generated by a user's selection. For doing so, the input device 260 includes a keypad including at least one hardware button, and a touchpad for detecting touch. For example, the input device 260 can provide touch information of the touch pad to the processor unit 220.

The electronic device 200 may further include a communication system (not shown) for wirelessly supporting communication with the other electronic device using radio resources. In so doing, the communication system can be divided into a plurality of communication sub-modules for supporting different networks. For example, the communication network includes, but is not limited to, a Global System for Mobile communication (GSM) network, an Enhanced Data GSM Environment (EDGE) network, a Code Division Multiple Access (CDMA) network, a W-CDMA network, a Long Term Evolution (LTE) network, an Orthogonal Frequency Division Multiple Access (OFDMA) network, a wireless Local Area Network (LAN), a Bluetooth network, and Near Field Communication (NFC).

As described above, the processor 220 controls to transmit and receive the control data and the user file to and from the other electronic device over the file transfer channel, inside a single module.

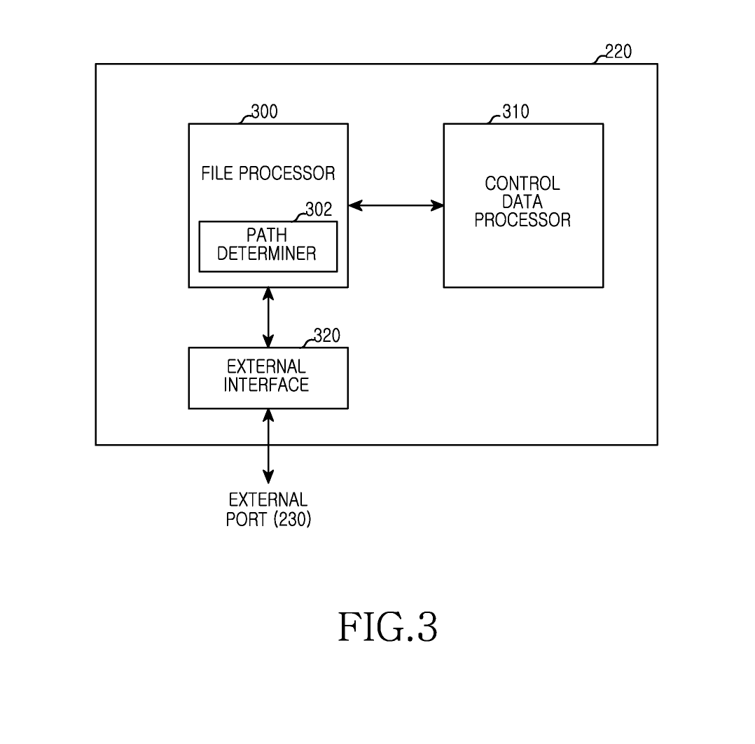

Alternatively, the processor 220 can include separate modules for controlling to transmit and receive the control data and the user file to and from the other electronic device over the file transfer channel as shown in FIG. 3.

FIG. 3 is a detailed block diagram of the processor according to an embodiment of the present invention.

As shown in FIG. 3, the processor 220 includes a file processor 300, a control data processor 310, and an external interface 320.

The file processor 300 processes the file received from the other electronic device through the external interface 320. For doing so, the file processor 300 includes a path determiner 302 for determining a transfer path of the corresponding file by identifying the type of the file fed from the external interface 320. For example, the file processor 300 can include a file application layer and a file transfer framework. The file transfer framework can indicate a class and a library for implementing an application program standard architecture for a particular Operating System (OS).

The path determiner 302, which is located in the file transfer framework, determines the path for sending the corresponding file according to the type of the file fed from the external interface 320. For example, the path determiner 302 can identify the user file or the control data file using the file header fed from the external interface 320. When the file fed from the external interface 320 is the control data file, the path determiner 302 sends the control data file to the control data processor 310. In so doing, the path determiner 302 sends control data extracted from the control data file to the control data processor 310. When the control data file fed from the external interface 320 is encrypted, the path determiner 302 decrypts the control data file and sends the extracted control data to the control data processor 310. In addition, the path determiner 302 may establish the control channel with the control data processor 310 according to the control data file for control channel configuration, and release the control channel with the control data processor 310 according to the control data file for control channel release. When the other electronic device requests to encrypt the control data file, the path determiner 302 generates an encryption key for encrypting the control data file when the control channel is set, and deletes the corresponding encryption key when the control channel is released.

When the file fed from the external interface 320 is the user file, the path determiner 302 sends the user file to a file application program. The file application program, which is where the application for executing the user file among application programs stored in the memory 210 operates, executes the user file fed from the path determiner 302.

The file processor 300 controls to transmit the user file and the control data file to the other electronic device through the external interface 320. For example, the file transfer framework of the file processor 300 controls to transmit the user file fed from the file application program to the other electronic device through the external interface 320. For example, the file transfer framework of the file processor 300 controls to generate the control data fed from the control data processor 310 as the file and to transmit the file to the other electronic device through the external interface 320. To encrypt the control data file, the file processor 300 encrypts the control data file with the encryption key generated in the control channel setting and sends the encrypted control data file to the external interface 320.

The control data processor 310 processes the control data fed from the path determiner 302 of the file processor 300. For example, the control data processor 310 controls the control command of the control data from the file processor 300. In so doing, the control data processor 310 can send a response signal of the control data to the file processor 300.

The external interface 320 controls the file processor 300 to send and receive the file via the external port 230. For example, the external interface 320 controls to send and receive the file to and from the other electronic device over the file transfer channel according to a file transfer driver.

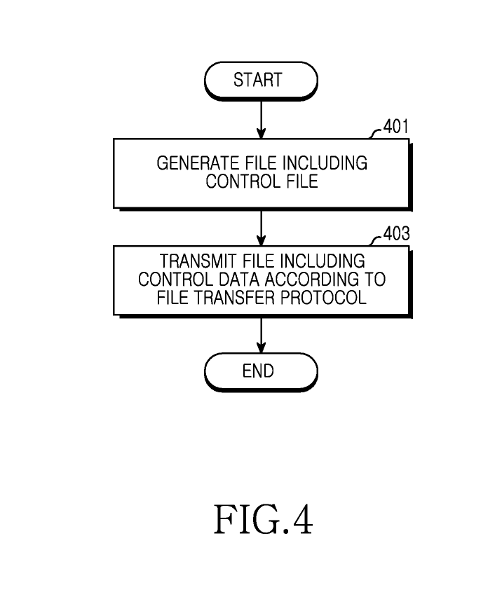

FIG. 4 is a flowchart of a method for transmitting the control data in the electronic device according to an embodiment of the present invention.

Referring to FIG. 4, the electronic device generates the file including the control file in step 401. For example, when the communication link is connected to the other electronic device through the external port 230, the file processor 300 of the electronic device 200 generates the control data file with the control data generated by the control data processor 310. In so doing, the file processor 300 may add identification information of the control data file to the header of the control data file.

In step 403, the electronic device transmits the control data file to the other electronic device over the file transfer channel according to the file transfer protocol. For example, the file processor 300 of the electronic device 200 transmits the control data file to the other electronic device connected via the communication link, through the external interface 320.

As such, the electronic device can transmit the control data file to the other electronic device over the file transfer channel. The electronic device may include a means for generating the control data file and a means for transmitting the control data file to the other electronic device over the file transfer channel.

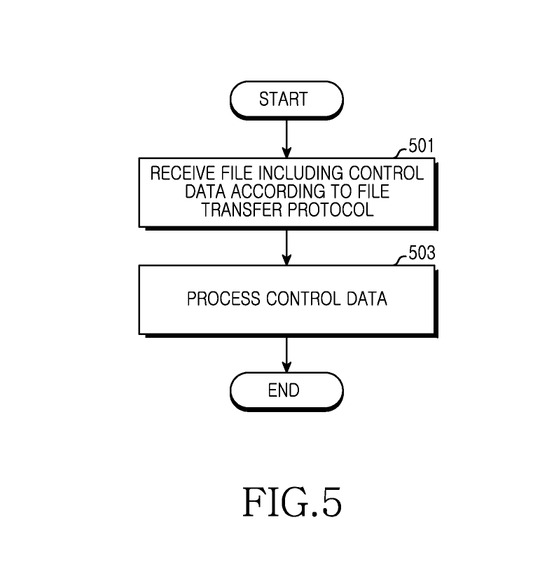

FIG. 5 is a flowchart of a method for processing the control data in the electronic device according to an embodiment of the present invention.

Referring to FIG. 5, the electronic device receives the control data file from the other electronic device connected via the communication link, over the file transfer channel in step 501. For example, the file processor 300 of the electronic device 200 identifies the control data file received from the other electronic device over the file transfer channel, using the path determiner 302. When the path determiner 302 identifies the control data file, the file processor 300 sends the control data of the control data file to the control data processor 310.

In step 503, the electronic device processes the control command of the control data according to the file transfer protocol. For example, the control data processor 310 of the electronic device 200 executes the control command of the control data fed from the file processor 300. In so doing, the control data processor 310 sends a response signal of the control data to the other electronic device through the file processor 300.

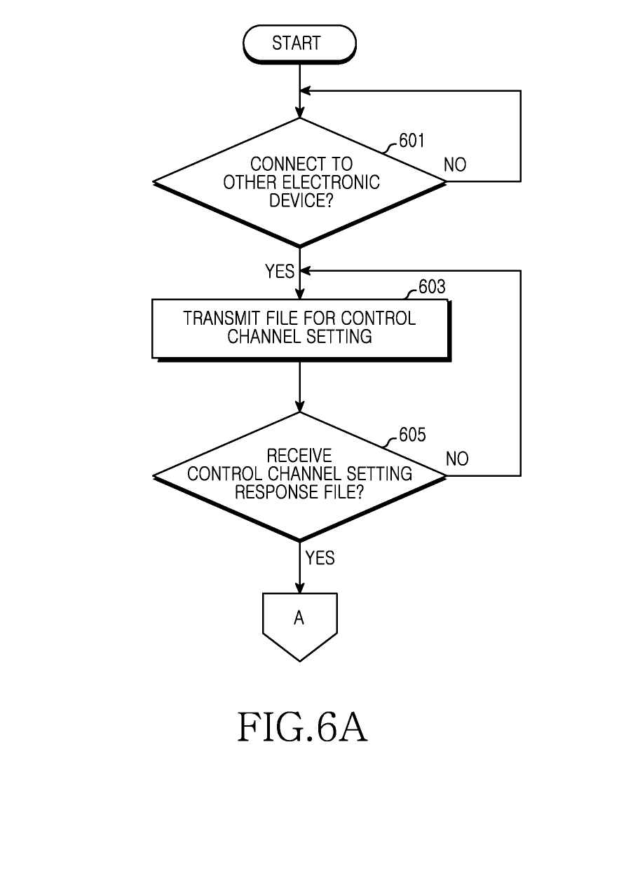

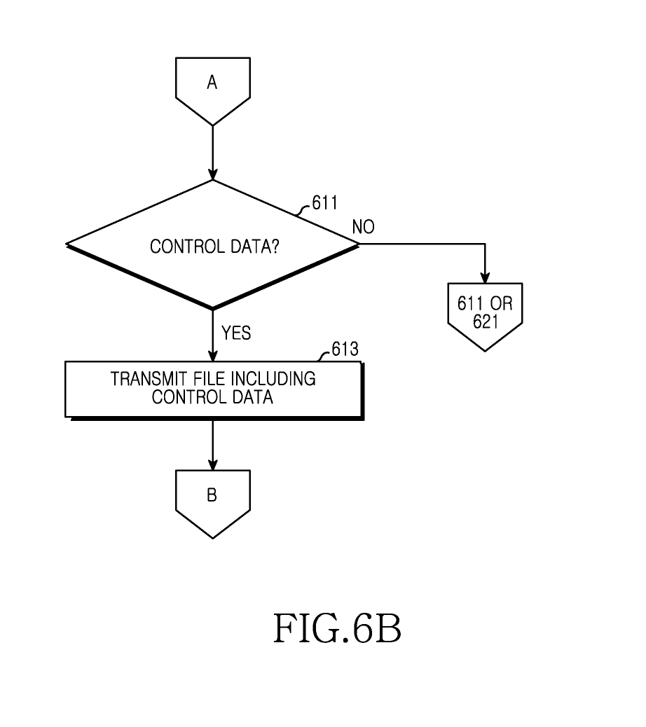

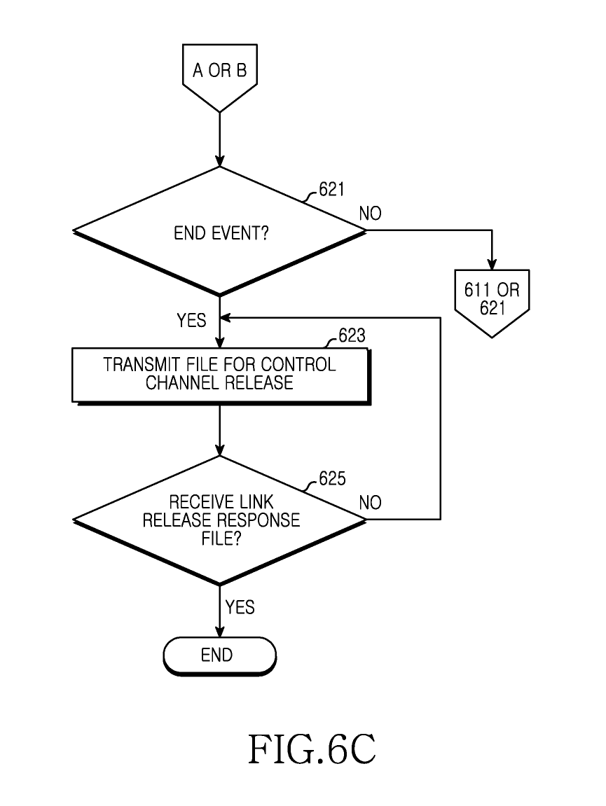

FIGS. 6A, 6B, and 6C are flowcharts of a method for transmitting the control data in the electronic device according to another embodiment of the present invention.

As shown in FIG. 6A, the electronic device determines whether the communication link is connected to the other electronic device in step 601. For example, the electronic device 200 determines whether a wired communication link is established with the other electronic device through the external port 230.

When the communication link is connected to the other electronic device, the electronic device generates and transmits the file for the control channel setting to the other electronic device over the file transfer channel in step 603. For example, when the communication link is set with the other electronic device through the external port 230, the control data processor 310 of the electronic device 200 sends a control channel setting signal to the file processor 300. In so doing, the file processor 300 generates the control channel setting signal as the file and transmits the control channel setting file to the other electronic device over the file transfer channel according to the file transfer protocol.

In step 605, the electronic device determines whether a control channel setting response file is received from the other electronic device over the file transfer channel.

When the control channel setting response file is not received during a reference time in step 605, the electronic device may resend the control channel setting file to the other electronic device in step 603.

Upon receiving the control channel setting response file in step 605, the electronic device determines whether the control data to send to the other electronic device exists in step 611 of FIG. 6B. For example, the electronic device 200 can determine, using the control data processor 310, whether the control data to send to the other electronic device exists.

When the control data to send to the other electronic device does not exist in step 611, the electronic device can continue to check the presence of the control data in step 611 or determine whether an end event occurs in step 621 of FIG. 6C.

Upon detecting that there is control data to send to the other electronic device in step 611, the electronic device generates and transmits the control data file to the other electronic device over the file transfer channel in step 613. For example, the file processor 300 of the electronic device 200 generates the control data file using the control data generated by the control data processor 310. In so doing, the file processor 300 may add the identification information of the control data file to the header of the control data file.

Although it is not illustrated here, the electronic device may determine whether the response file of the control data is received from the other electronic device over the file transfer channel. When the response file of the control data is not received within the reference time, the electronic device may resend the control data to the other electronic device.

When the control channel setting response file is received in step 605 of FIG. 6A, when the control data to send to the other electronic device is not detected in step 611 of FIG. 6B, or when the control data file is sent in step 613 of FIG. 6B, the electronic device determines whether the end event occurs in step 621 of FIG. 6C. For example, the electronic device 200 can determine whether a connection end menu with the other electronic device is selected according to input information fed from the input part 260.

When the end event does not occur in step 621, the electronic device can continue to determine whether the end event occurs in step 621 or return to step 611 of FIG. 6B determine whether the control data to send to the other electronic device exists.

When the end event takes place in step 621, the electronic device generates and transmits the control channel release file to the other electronic device over the file transfer channel in step 623. For example, for the end event, the control data processor 310 of the electronic device 200 sends the control channel release signal to the file processor 300. The file processor 300 then generates and transmits the control channel release file to the other electronic device over the file transfer channel according to the file transfer protocol.

In step 625, the electronic device determines whether the control channel release response file is received from the other electronic device over the file transfer channel.

When the control channel release response file is not received within the reference time in step 625, the electronic device may resend the control channel release file to the other electronic device in step 623.

When the control channel release response file is received in step 625, the electronic device releases the communication link with the other electronic device and ends the process.

As described above, the electronic device can transmit the control data file to the other electronic device over the file transfer channel. In so doing, the electronic device may transmit the user file over the file transfer channel.

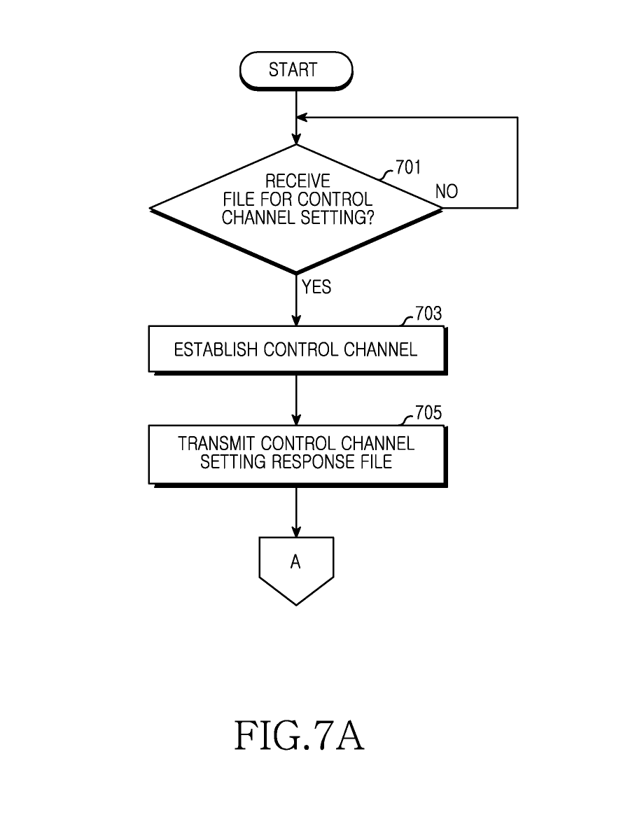

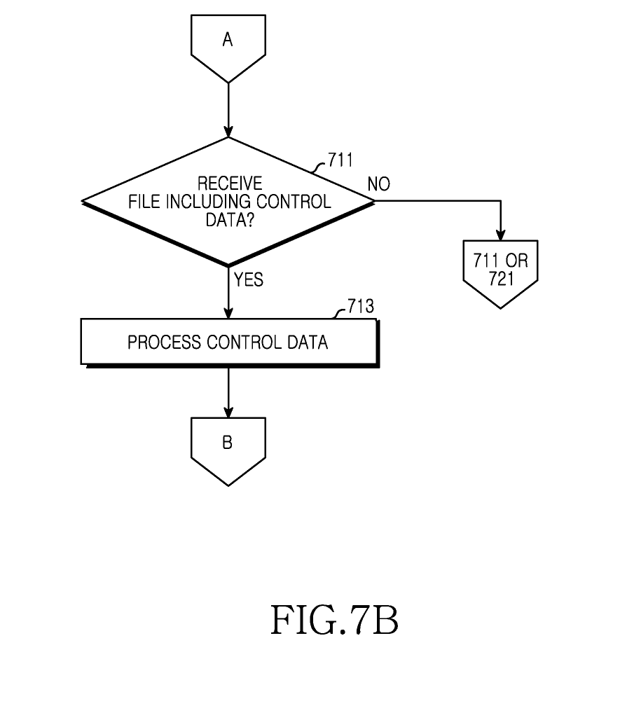

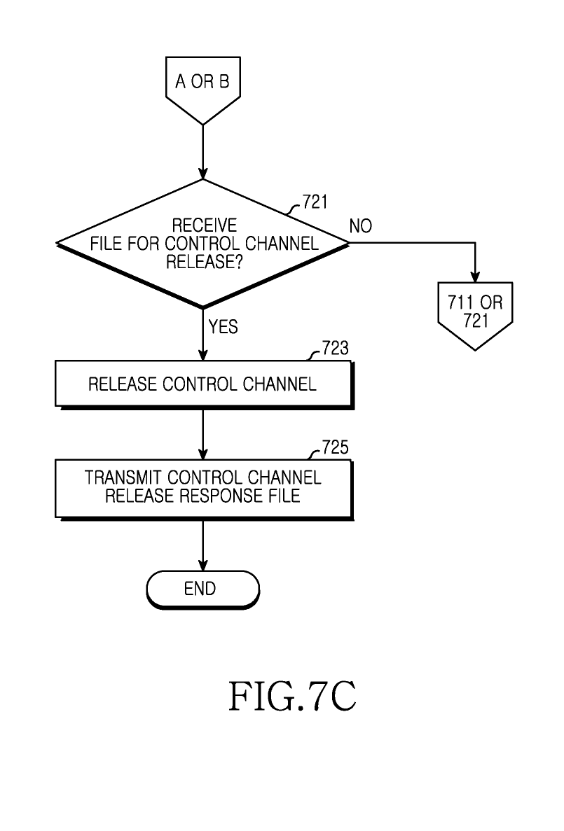

FIGS. 7A, 7B, and 7C are flowcharts of a method for processing the control data in the electronic device according to another embodiment of the present invention.

As shown in FIG. 7A, the electronic device determines whether the control channel setting file is received from the other electronic device over the file transfer channel in step 701. For example, when establishing the wired communication link with the other electronic device through the external port 230, the electronic device 200 determines whether the control channel setting file is received from the other electronic device over the file transfer channel.

Upon receiving the control channel setting file in step 701, the electronic device sets the control channel in step 703. For example, when the control channel setting file is received over the file transfer channel, the file processor 300 of the electronic device 200 sets the control channel with the control data processor 310.

In step 705, the electronic device transmits the response file of the control channel setting file to the other electronic device over the file transfer channel. For example, when the control channel is established with the control data processor 310, the file processor 300 generates the response signal fed from the control data processor 310 as the file and transmit the response file to the other electronic device.

Next, the electronic device determines whether the control data file is received from the other electronic device in step 711 of FIG. 7B. For example, the path determiner 302 of the file processor 300 can identify the control data file by analyzing the header information of the file received over the file transfer channel.

When the control data file is not received from the other electronic device in step 711, the electronic device can continue to determine whether the control data file is received in step 711 or determine whether the control channel release data is received in step 721 of FIG. 7C.

When the control data file is received from the other electronic device in step 711, the electronic device processes the control command of the control data in step 713. For example, when the path determiner 302 identifies the control data file, the file processor 300 sends the control data including the control data file to the control data processor 310. The control data processor 310 executes the control command of the control data fed from the file processor 300. In so doing, the control data processor 310 transmits the response signal of the control data to the other electronic device through the file processor 300.

When sending the response file of the control channel setting in step 705 of FIG. 7A, when the control data file is not received from the other electronic device in step 711 of FIG. 7B, or when processing the control command in step 713 of FIG. 7B, the electronic device determines whether the control channel release file is received from the other electronic device over the file transfer channel in step 721 of FIG. 7C.

When the control channel release file is not received in step 721, the electronic device can continue to determine whether the control channel release file is received in step 721 or determine whether the control data file is received in step 711 of FIG. 7B.

Upon receiving the control channel release file in step 721, the electronic device releases the control channel in step 723. For example, when receiving the control channel release file over the file transfer channel, the file processor 300 of the electronic device 200 releases the control channel with the control data processor 310.

In step 725, the electronic device transmits the response file of the control channel release file to the electronic device over the file transfer channel. For example, when the control channel is established with the control data processor 310, the file processor 300 generates and transmits the control channel release file to the other electronic device.

As above, the file processor 300 of the electronic device sends the control data to the control data processor 310 over the control channel of the control data processor 310. When the control data file is received from the other electronic device before the control channel is established with the control data processor 310, the file processor 300 may transmit control data process error information to the other electronic device.

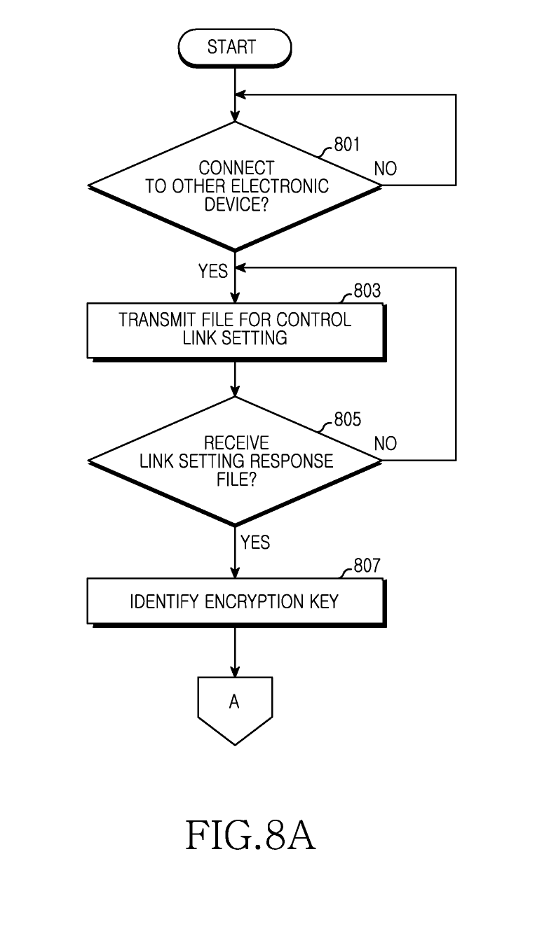

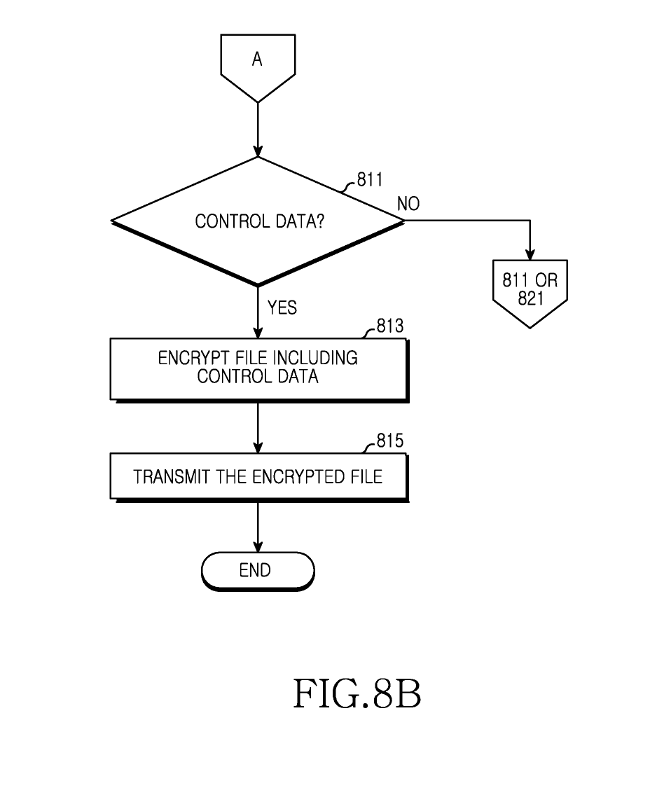

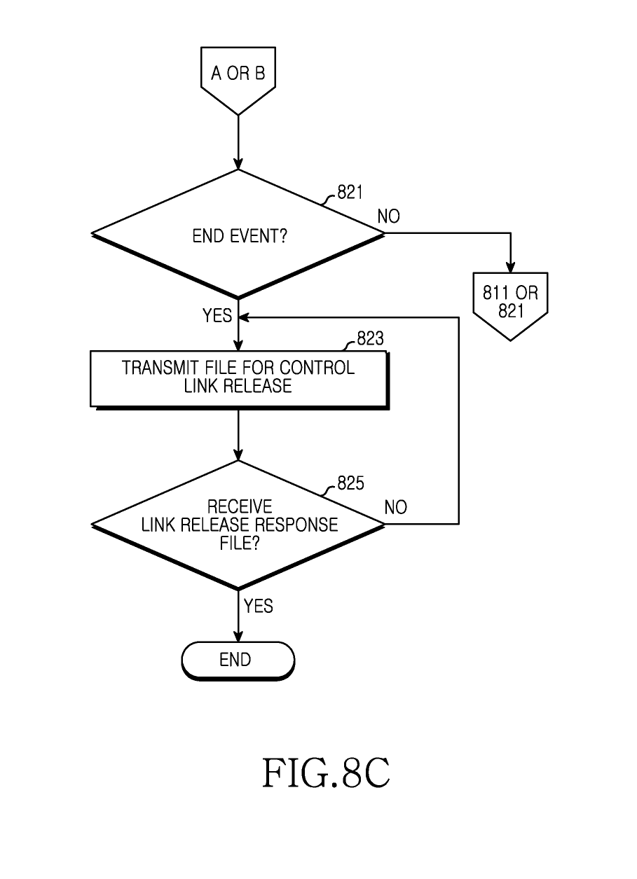

FIGS. 8A, 8B, and 8C are flowcharts of a method for transmitting the control data in the electronic device according to another embodiment of the present invention.

As shown in FIG. 8A, the electronic device determines whether the communication link is connected to the other electronic device in step 801. For example, the electronic device 200 can determine whether the wired communication link is established with the other electronic device through the external port 230.

When the communication link is connected to the other electronic device in step 801, the electronic device generates and transmits the control channel setting file to the other electronic device over the file transfer channel in step 803. For example, when the communication link is established with the other electronic device through the external port 230, the control data processor 310 of the electronic device 200 sends the control channel setting signal to the file processor 300. In so doing, the file processor 300 generates the control channel setting signal as the file and transmits the control channel setting file to the other electronic device over the file transfer channel.

In step 805, the electronic device determines whether the control channel setting response file is received from the other electronic device over the file transfer channel.

When the control channel setting response file is not received during the reference time in step 805, the electronic device may resend the control channel setting file to the other electronic device in step 803.

Upon receiving the control channel setting response file in step 805, the electronic device identifies the encryption key of the control channel setting response file in step 807.

In step 811 of FIG. 8B, the electronic device determines whether the control data to send to the other electronic device exists. For example, the electronic device 200 determines using the control data processor 310, whether the control data to send to the other electronic device exists.

When the control data to send to the other electronic device does not exist in step 811, the electronic device can continue to check the presence of the control data in step 811 or determine whether the end event occurs in step 821 of FIG. 8C.

Upon detecting the control data to send to the other electronic device exists in step 811, the electronic device encrypts the control data file with the encryption key in step 813. For example, the file processor 300 of the electronic device 200 generates the control data file using the control data generated by the control data processor 310. In so doing, the file processor 300 may add the identification information of the control data file to the header of the control data file. Next, the file processor 300 encrypts the control data file with the encryption key received from the other electronic device.

In step 815, the electronic device transmits the encrypted control data file to the other electronic device over the file transfer channel. For example, the file processor 300 of the electronic device 200 transmits the encrypted control data file to the other electronic device over the file transfer channel according to the file transfer protocol.

Although it is not illustrated here, the electronic device may determine whether the response file of the control data is received from the other electronic device over the file transfer channel. When the response file of the control data is not received within the reference time, the electronic device may resend the control data to the other electronic device.

When checking the encryption key for the communication with the other electronic device in step 807 of FIG. 8A, when detecting that there is no control data to send to the other electronic device in step 811 of FIG. 8B, or when sending the control data file in step 815 of FIG. 8B, the electronic device can determine whether the end event occurs in step 821 of FIG. 8C. For example, the electronic device 200 determines whether the connection end menu with the other electronic device is selected according to the input information fed from the input part 260.

When end event does not occur in step 821, the electronic device can continue to determine whether the end event occurs in step 821 or determine whether the control data to send to the other electronic device exists in step 811 of FIG. 8B.

When the end event takes place in step 821, the electronic device generates and transmits the control channel release file to the other electronic device over the file transfer channel in step 823. For example, for the end event, the control data processor 310 of the electronic device 200 sends the control channel release signal to the file processor 300. The file processor 300 generates the control channel release signal as the file and encrypts the file with the encryption key. Next, the file processor 300 transmits the encrypted control channel release file to the other electronic device over the file transfer channel according to the file transfer protocol.

In step 825, the electronic device determines whether the control channel release response file is received from the other electronic device over the file transfer channel.

When the control channel release response file is not received within the reference time in step 825, the electronic device may resend the control channel release file to the other electronic device in step 823.

When receiving the control channel release response file in step 825, the electronic device releases the communication link to the other electronic device and ends the process.

As such, the electronic device can transmit the control data file to the other electronic device over the file transfer channel. In so doing, the electronic device may transmit the user file over the file transfer channel.

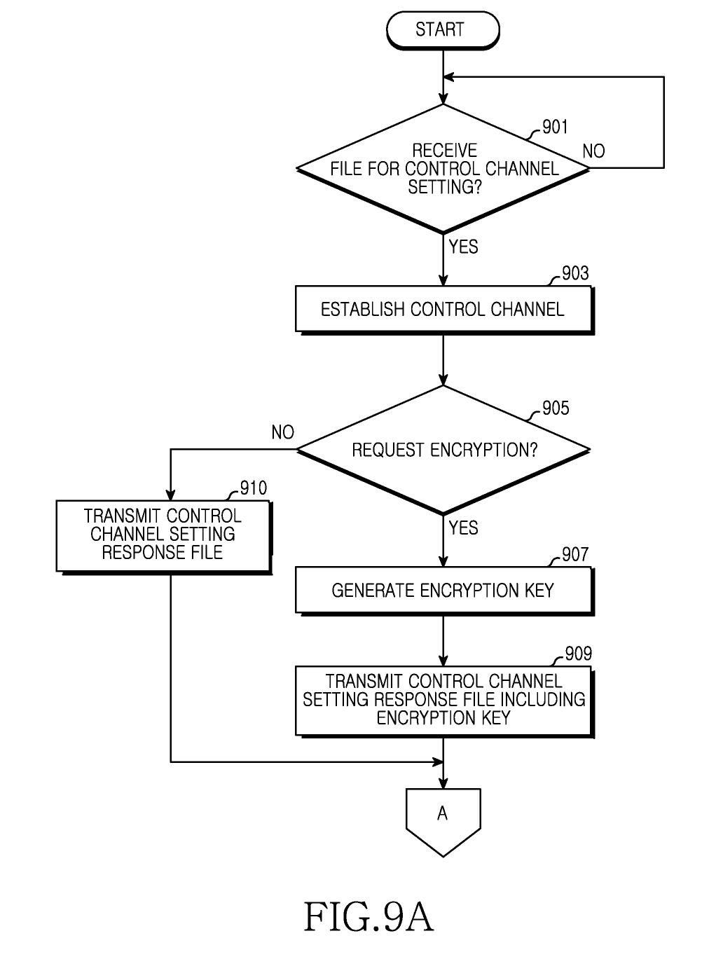

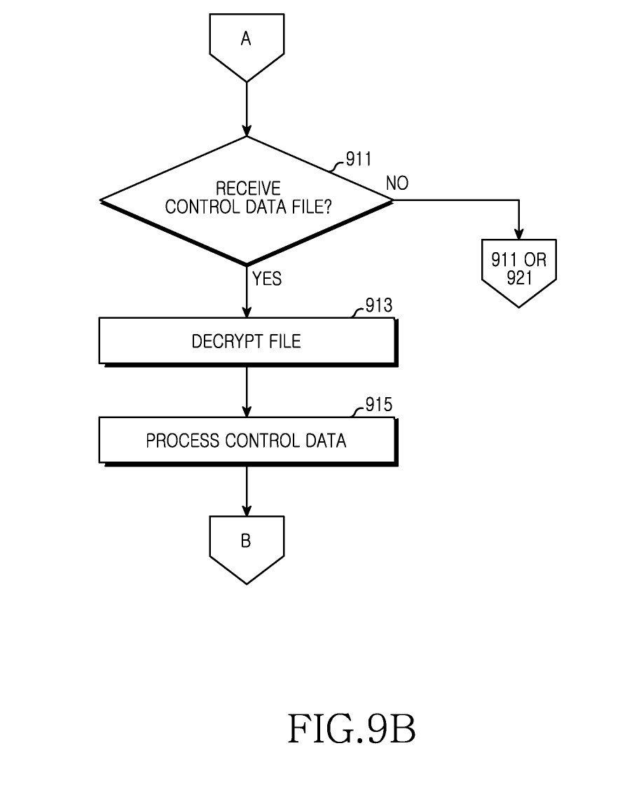

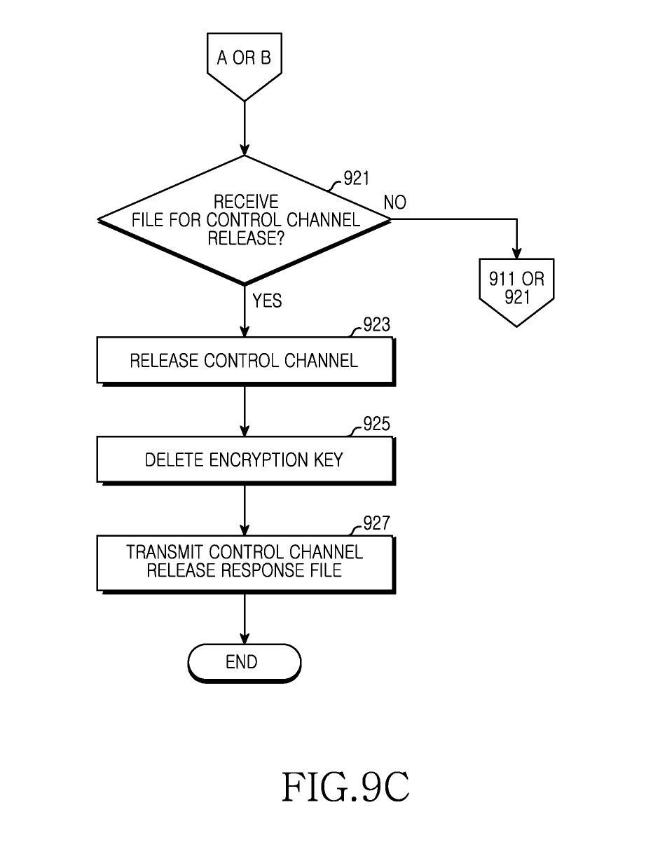

FIGS. 9A, 9B, and 9C are flowcharts of a method for processing the control data in the electronic device according to another embodiment of the present invention.

As shown in FIG. 9A, the electronic device determines whether the control channel setting file is received from the other electronic device over the file transfer channel in step 901. For example, when establishing the wired communication link with the other electronic device through the external port 230, the electronic device 200 determines whether the control channel setting file is received from the other electronic device over the file transfer channel.

Upon receiving the control channel setting file in step 901, the electronic device sets the control channel in step 903. For example, when the control channel setting file is received over the file transfer channel, the file processor 300 of the electronic device 200 sets the control channel with the control data processor 310.

In step 905, the electronic device determines whether the other electronic device requests to encrypt the control data file using the control channel setting file.

When the other electronic device does not request the encryption in step 905, the electronic device transmits the response file of the control channel setting file to the other electronic device over the file transfer channel in step 910. For example, when the control channel is established with the control data processor 310, the file processor 300 generates the response signal fed from the control data processor 310 as the file and transmits the response file to the other electronic device.

When the other electronic device requests the encryption in step 905, the electronic device generates the encryption key for encrypting the control data file in step 907. For example, the file processor 300 of the electronic device 200 can generate the encryption key for encrypting the control data file, or the control data processor 310 of the electronic device 200 may generate the encryption key for encrypting the control data file.

In step 909, the electronic device transmits the response file of the control channel setting file including the encryption key to the other electronic device over the file transfer channel. For example, the electronic device generates the control channel setting response file including the response signal and the encryption key fed from the control data processor 310. Next, the file processor 300 adds the encryption key to the control channel setting response file and transmits the response file to the other electronic device.

Next, the electronic device determines whether the control data file is received from the other electronic device in step 911 of FIG. 9B. For example, the path determiner 302 of the file processor 300 can identify the control data file by analyzing the header information of the file received over the file transfer channel.

When the control data file is not received from the other electronic device, the electronic device can continue to determine whether the control data file is received in step 911 of FIG. 9B or determine whether the control channel release data is received in step 921 of FIG. 9C.

When the control data file is received from the other electronic device in step 911, the electronic device decrypts the control data file in step 913. For example, the file processor 300 of the electronic device 200 decrypts the control data file with the encryption key generated in step 907 of FIG. 9A.

In step 915, the electronic device processes the control command of the control data. For example, the control data processor 310 executes the control command of the control data fed from the file processor 300. In so doing, the control data processor 310 may transmit the response signal of the control data to the other electronic device through the file processor 300.

When sending the response file for the control channel setting in step 909 or step 910 of FIG. 9A, when the control data file is not received from the other electronic device in step 911 of FIG. 9B, or when processing the control command in step 915 of FIG. 9B, the electronic device determines whether the control channel release file is received from the other electronic device over the file transfer channel in step 921 of FIG. 9C.

When the control channel release file is not received in step 921, the electronic device can continue to determine whether the control channel release file is received in step 921 or determine whether the control data file is received in step 911 of FIG. 9B.

Upon receiving the control channel release file in step 921, the electronic device releases the control channel in step 923. For example, when receiving the control channel release file over the file transfer channel, the file processor 300 of the electronic device 200 decrypts the control channel release file with the encryption key generated in step 907 of FIG. 9A. When the control channel release file is decrypted, the file processor 300 releases the control channel with the control data processor 310.

In step 925, the electronic device deletes the encryption key for encrypting the control data file.

In step 927, the electronic device transmits the response file of the control channel release file to the other electronic device over the file transfer channel. For example, when the control channel is established with the control data processor 310, the file processor 300 generates and transmits the control channel release file to the other electronic device.

As described above, the file processor 300 of the electronic device can decrypt the control data file received over the file transfer channel and send the decrypted control data file to the control data processor 310. When the control data file cannot be decrypted, the file processor 300 may transmit a control data process error information to the other electronic device.

As set forth above, the electronic device transmits and receives the control data to and from the other electronic device connected via the communication link, over the file transfer channel. Therefore, it is possible to reduce the cost of installing drivers for the file transmission and the control data transmission and the cost of maintaining the channel, and there is no need to retain a separate encryption module for the control data.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An electronic device comprising:
a control data processor configured to generate control data; and
a file processor configured to generate a control data file comprising the control data generated by the control data processor, and to transmit the control data file to another electronic device using a file transfer protocol.

2. The device of claim 1, wherein the control data comprises serial data.

3. The device of claim 1, wherein the control data processor is configured to generate a control channel setting signal when a wired communication link is connected to the other electronic device, and
the file processor is configured to generate a control channel setting file comprising the control channel setting signal generated by the control data processor and to transmit the control channel setting file to the other electronic device using the file transfer protocol.

4. The device of claim 1, wherein the file processor is configured to generate a control data file comprising the control data and to encrypt the control data file with an encryption key received from the other electronic device.

5. The device of claim 1, wherein the file processor is configured to generate a control channel release file for a control channel release signal generated by the control data processor according to an end event, to transmit the control channel release file to the other electronic device using the file transfer protocol, and to release a wired communication link with the other electronic device when receiving a response file of the control channel release file.

6. An electronic device comprising:
a file processor configured to receive a control data file from another electronic device over a file transfer channel, and to extract control data from the control data file; and
a control data processor configured to process a control command of the control data extracted by the file processor.

7. The device of claim 6, wherein the control data comprises serial data.

8. The device of claim 6, wherein, when receiving a control channel setting file from the other electronic device connected via a wired communication link, the file processor is configured to establish a control channel with the control data processor.

9. The device of claim 8, wherein the file processor sends the control data of the control data file to the control data processor over the control channel.

10. The device of claim 8, wherein when the control channel is established between the file processor and the control data processor, the file processor is configured to generate an encryption key, to generate a control channel setting response file comprising the encryption key, and to transmit the control channel setting response file to the other electronic device over the file transfer channel.

11. The device of claim 6, wherein, when receiving a control channel release file from the other electronic device over the file transfer channel, the file processor is configured to release the control channel with the control data processor and to transmit the control channel release response file to the other electronic device over the file transfer channel.

12. A method in an electronic device, comprising:
generating a control data file comprising control data; and
transmitting the control data file to another electronic device using a file transfer protocol.

13. The method of claim 12, wherein the control data comprises serial data.

14. The method of claim 12, further comprising:
before generating the control data file, when a wired communication link is connected to the other electronic device, generating a control channel setting signal, and
transmitting the control channel setting file to the other electronic device using the file transfer protocol.

15. The method of claim 12, wherein generating the control data file comprises:
generating a control data file comprising the control data; and
encrypting the control data file with an encryption key received from the other electronic device.

16. The method of claim 12, further comprising:
when an end event occurs, generating a control channel release file;
transmitting the control channel release file to the other electronic device using the file transfer protocol; and
when receiving a response file of the control channel release file, releasing a wired communication link with the other electronic device.

17. A method in an electronic device, comprising:
receiving a control data file from another electronic device over a file transfer channel, and
extracting control data from the control data file and processing a control command of the control data.

18. The method of claim 17, wherein the control data comprises serial data.

19. The method of claim 17, further comprising:
before receiving the control data file, receiving a control channel setting file from the other electronic device connected via a wired communication link; and
establishing a control channel with a control data processor according to the control channel setting file.

20. The method of claim 19, wherein processing the control command comprises:
sending the control data of the control data file to the control data processor over the control channel; and
processing the control command of the control data in the control data processor.

21. The method of claim 19, further comprising:
after establishing the control channel, generating an encryption key;
generating a control channel setting response file including the encryption key; and
transmitting the control channel setting response file to the other electronic device over the file transfer channel.

22. The method of claim 17, further comprising:
when receiving a control channel release file from the other electronic device over the file transfer channel, releasing the control channel with the control data processor; and
transmitting a control channel release response file to the other electronic device over the file transfer channel.
